(19) United States
(12) Patent Application Publication
(10) Pub. No.: US 2014/0335415 A1
(43) Pub. Date: Nov. 13, 2014

(54) Battery electrode having elongated particles embedded in active medium

(71) Applicants: Ryo Tamaki, Santa Clarita, CA (US); Mikito Nagata, Saugus, CA (US); Hisashi Tsukamoto, La Canada Flintridge, CA (US)

(72) Inventors: Ryo Tamaki, Santa Clarita, CA (US); Mikito Nagata, Saugus, CA (US); Hisashi Tsukamoto, La Canada Flintridge, CA (US)

(21) Appl. No.: 13/066,582

(22) Filed: Apr. 18, 2011

Related U.S. Application Data
(63) Continuation of application No. 12/931,436, filed on Jan. 31, 2011, now abandoned.

(51) Int. Cl. H01M 4/485; H01M 4/583; H01M 4/04; H01M 4/62

(52) U.S. Cl. 429/231.1; 429/232; 429/231.8; 29/623.1

(57) ABSTRACT

The battery includes one or more electrodes that each has an active layer on a current collector. The active layer including active particles. The active particles include elongated particles embedded in an active medium such that at least a portion of the elongated particles each extends from within the active medium past a surface of the active medium.

### RELATED APPLICATIONS

This Application is a Continuation of U.S. patent application Ser. No. 12/931,436, filed Jan. 31, 2011, entitled “Battery Electrode Having Elongated Particles Embedded in Active Medium,”, and this application claims the benefit of U.S. Provisional Patent Application Ser. No. 61/337,177, filed Jan. 29, 2010, entitled “Battery Electrode Having Elongated Particles Embedded in Active Medium,” each of which is incorporated herein in its entirety.

### FIELD

The present invention relates to power sources and more particularly to batteries.

### BACKGROUND

A number of battery applications require a battery that can provide both high capacity and high power.

### SUMMARY

The battery includes one or more electrodes that each has an active layer on a current collector. The active layer including active particles. The active particles include elongated particles embedded in an active medium such that at least a portion of the elongated particles each extends from within the active medium past a surface of the active medium.

A method of forming an electrode for a battery includes forming separated elongate particles into a bundle. The method also includes growing an active medium in an interior of the bundles after forming the bundles. The active material is formed such that at least a portion of the elongated particles each extends from within the active medium past a surface of the active medium.

### BRIEF DESCRIPTION OF THE FIGURES

FIG. 1A is a cross section of an active particle. The active particles include elongated particles and an active medium. The active medium includes one or more active materials.

FIG. 1B is a cross section of an active particle. The active particles include elongated particles and an active medium. The active medium contacts a coating.

FIG. 1C is a cross section of an active particle. The active particles include elongated particles and an active medium. The active medium contacts a coating. The coating illustrated in FIG. 1B is thicker than the coating of FIG. 1B.

FIG. 2A and FIG. 2B illustrates an electrode that includes active particles according to FIG. 1A and/or FIG. 1B and/or FIG. 1C. FIG. 2A is a sideview of the electrode. FIG. 2B is a cross section of the electrode shown in FIG. 2A taken along the line labeled B in FIG. 2A

### DESCRIPTION

A battery includes one or more electrodes that each includes active particles. The active particles include elongated particles and an active medium. The active medium includes one or more active materials. The elongated particles are embedded in the active medium. At least a portion of the elongated particles each extends from within the active medium beyond the surface of the active medium. As a result, at least a portion of the elongated particles have an end located outside of the active medium. For instance, the elongated particles can have a shape such as a wire and a portion of the wires can each have one end embedded in the active medium but have the other end outside of the active medium.

In some instances, the elongated particles are electrically conducting. As a result, the elongated particles can conduct electrical current into a central location within the active particle and/or from a central location within the active particle. Additionally, the elongated particles extending past the surface of the active medium provides electrical pathways between different active particles. These features combine to enhance the electrical conductivity of the electrode and accordingly enhances the power that is available from the battery.

In some instances, the active medium is porous. The electrolyte can enter the pores. As a result, the interface area between the active medium and the electrolyte is increased. The increase interface area enhances ion exchange within the active medium. Additionally, the entry of the electrolyte into the pores increases the ion exchange within the active medium in locations where the ion exchange would not occur in the absence of a porous active medium. The enhanced ion exchange further increases the power of the battery.

The enhanced power of the battery allows the battery make use of low power active materials. For instance, the one or more active materials can be an active material that is traditionally associated with applications that require high capacity but not high power. As a particular example, the one or more active materials can be carbon materials such as soft carbon. While these materials are traditionally associated with low power applications, they generally have higher energy capacity than active materials associated with high power applications. Since the battery can make use of these high capacity active materials, the battery can provide both high power and high capacity.

In some instances, elongated particles have high ionic capacity in addition to the electrical conductivity or as an alternative to the electrical conductivity. For instance, materials such as silicon wire, tin wire, lithium wire or indium wire have the ability to hold large amounts of lithium ions making them suitable for use in negative electrodes. The capacity of the electrodes increases as a result of this ability to hold the lithium ions. Accordingly, the elongated particles can enhance the capacity of the battery further increasing the ability of the battery to provide both high power and high capacity.

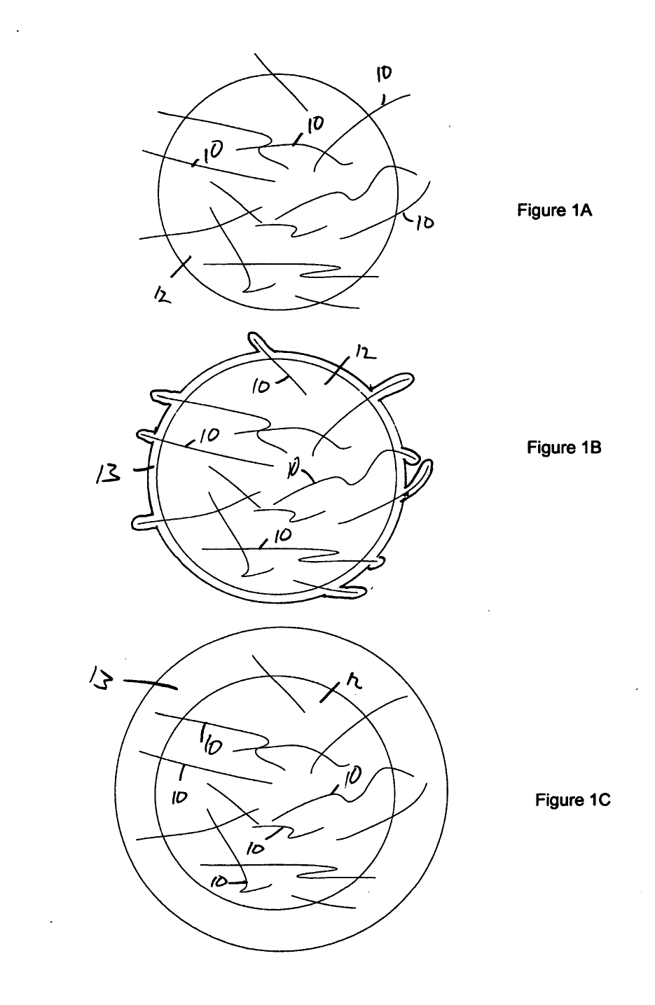

FIG. 1A is a cross section of an active particle. The active particles include elongated particles 10 and an active medium 12. The active medium 12 includes one or more active materials. The elongated particles 10 are embedded in the active medium 12. At least a portion of the elongated particles 10 extends from within the active medium 12 beyond the surface of the active medium 12. As a result, at least a portion of the elongated particles 10 each has an end located outside of the active medium 12 and another end located inside of the active medium 12.

As is evident from Figure IA, a portion of the elongated particles 10 are positioned entirely in the active medium 12 but another portion of the elongated particles 10 extends from within the active medium 12 beyond a surface of the active medium 12. A portion of the elongated particles 10 that extend beyond the surface of the active medium 12 can contact one another within the active medium 12. In some instances, in order to increase the conductivity of the active particles, an average of more than 0.1%, 1% or 10% of the elongated particles 10 have a portion that extends beyond a surface of the active medium 12.

The elongated particles 10 that extend beyond the surface of the active medium 12 can extend an average of more than 1 nm, more than 10 nm, or more than 100 nm beyond the surface of the active medium 12 and/or less than 100 μm, less than 10 or less than 1 μm beyond the surface of the active medium 12. The active particle can have the shape of spheres, flakes, or fibers. In some instances, at least a portion of the elongated particles 10 that extend beyond the surface of the active medium 12 have an embedded length that is greater than 50%, 25%, or 10% of the average active particle diameter where the embedded length of an elongated particle 10 is the length of the portion of the elongated particle 10 that is positioned in the active medium 12.

An aspect ratio of the elongated particles 10 is a ratio of a length of an elongated particle 10 to a width of the elongated particle 10. In some instances, the elongated particles 10 have an average aspect ratio greater than 1, 10, or 100 and/or less than 1,000,000, 100,000, or 10,000. In some instances, the average diameters of the elongated particles 10 range from 1/10,000 to 1/10, or 1/1,000 to 1/100, of the average diameter of the one or more active materials.

In some instances, the active particles consist of the one or more active materials and the elongated particles 10; however, in some instances, the active particles include materials in addition to the one or more active materials and the elongated particles 10. For instance, in addition to the one or more active materials and the elongated particles 10, the active particles can include a binder. Examples of binder include, but are not limited to, silica, alumina, and titania.

The elongated particles 10 be an average of more than 0.1 wt %, more than 1 wt %, or more than 5 wt %, and/or less than 90 wt %, less than 75 wt %, or less than 50 wt % of the total average weight of the active particles. The one or more active materials can be an average of more than 10 wt %, more than 25 wt %, or more than 50 wt %, and/or less than 99.9 wt %, less than 99 wt %, or less than 95 wt % of the total average weight of the active particles. When the active particles include a binder, the amount of binder included in the active particles be an average of more than 0.01 wt %, more than 0.1 wt %, or more than 1 wt %, and/or less than 10 wt %, less than 7.5 wt %, or less than 5 wt % of the total average weight of the active particles.

The active medium 12 can be porous. Suitable pores include, but are not limited to, pores, holes, openings, channels, or other conduits. The pores can be irregular shape and/or spacing or can have consistent shapes and/or spacing. A suitable porosity for the active medium 12 includes, but is not limited to, porosity greater than 1%, or 10%, and/or less than 50%, or 30% where the porosity is the percentage of the total active particle volume taken up by pores averaged over the active particles.

The active particles can optionally include a coating 13. FIG. 1B is a cross section of an active particle that includes the elongated particles and an active medium. The active particles include a coating. The coating is formed on both the active medium and on the elongated particles. For instance, the coating contacts the active medium and also contacts the portion of elongated particles located outside of the active medium. During operation of a battery that includes the active particles, certain elongated particles expand and contract. The coating can prevent the breakage of these elongated particles that can be caused by the expansion and contraction.

The coating illustrated in FIG. 1B includes elongated portions positioned on the elongated particles and medium portions located on the active medium. The elongated portions of the coating extend outward from the medium portions. However, as shown in FIG. 1C, the coating can be thick enough that the outer surface of the coating substantially follows the contour of the underlying active medium. A suitable average thickness for the coating includes, but is not limited to, coatings having an average thickness greater than 1 nm, 10 nm, or 100 nm and/or less than 100 μm, 10 μm, or 1 μm.

Suitable coatings include or consist of electrically conducting and/or ion conducting materials such as lithium ion conducting materials. Examples of suitable coatings include or consist of carbonaceous materials such as amorphous carbon, soft carbon or hard carbon. Other examples of suitable coatings include or consist of lithium-ion conductive ceramics such as lithium titanate. Examples of suitable lithium-ion conductive ceramics includes the lithium ion conductive glass-ceramics disclosed in U.S. patent application Ser. No. 12/231,801, filed on Sep. 4, 2008, entitled “Battery Having Ceramic Electrolyte,” and incorporated herein in its entirety and also in U.S. Provisional patent application Ser. No. 12/231,801, filed on Sep. 6, 2007, entitled “Battery Having Ceramic Electrolyte,” and incorporated herein in its entirety. Other examples of suitable coatings include or consist of carbonized polymeric material such as carbonized polycarbonate, carbonized sucrose, carbonize polymethylmethacrylate, carbonized polyvinyl chloride, carbonized polyvinyl alcohol.

When the active particles include a coating, the amount of coating included in the elongated particles 10 be an average of more than 0.01 wt %, more than 0.1 wt %, or more than 1 wt %, and/or less than 10 wt %, less than 7.5 wt %, or less than 5 wt % of the total average weight of the active particles.

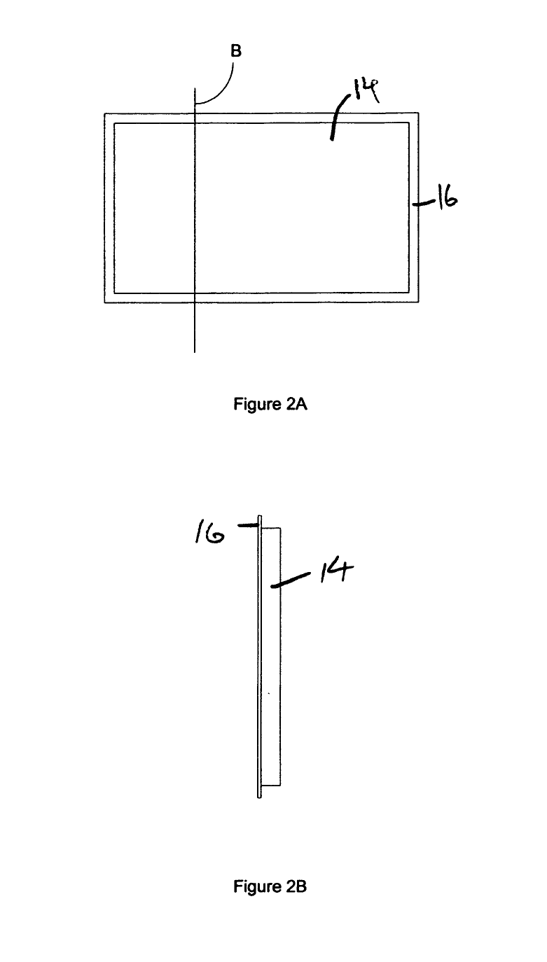

FIG. 2A and FIG. 2B illustrates an electrode. FIG. 2A is a sideview of the electrode. FIG. 2B is a cross section of the electrode shown in FIG. 2A taken along the line labeled B in FIG. 2A. The electrode includes an active layer 14 on a side of a current collector 16. Although FIG. 2A and FIG. 2B illustrate the active layer 14 on one side of a substrate, the active layer 14 can be positioned on both sides of the substrate.

The active particles can be included in the active layer 14 of a positive electrode (or a cathode) or a negative electrode (or an anode). When the active particles are included in the active material of either a positive or negative electrode, the elongated particles can be electrically conducting. Examples of suitable elongated particles that are electrically conducting include, but are not limited to, carbon fibers, carbon nanofibers, carbon nanotubes, metal wires, metal nanowires. When the active particles are included in a negative electrode, the capacity of the electrode can be increased when the active materials have a capacity to hold ions such as lithium ions. Accordingly, the elongated particles can have high ionic capacity in addition to the electrical conductivity or as an alternative to the electrical conductivity. A suitable lithium ion holding capacity is greater than 100 mAh/g, 500 mAh/g, or 1,000 mAh/g. Examples of suitable elongated particles that are electrically conducting and also have an elevated ionic capacity include, but are not limited to, silicon wire, lithium wire, tin wire, and indium wire. The active materials can include combinations of different elongated particles. For instance, the active materials can include elongated particles that are electrically conducting and also elongated particles with substantial ion holding capacity.

When the active particles are included in a negative electrode, suitable active materials for inclusion in the active medium include, but are not limited to, mesophase carbon (MC), mesocarbon microbeads (MCMB), mesophase carbon fiber (MCF), soft carbon, hard carbon, fluorinated carbon, and lithium titanate. Additionally, when the active particles are included in a negative electrode, suitable current collectors include, but are not limited to, copper, nickel, and titanium. The current collector can be a foil, mesh, net or plate.

When the active particles are included in a negative electrode, the active layer can consist of the active particles; however, in some instances, the active layer can include materials in addition to the active particles. For instance, in addition to the active particles, the active layer can include one or more components selected from a group consisting of binders, conductors and/or diluents. Suitable binders include, but are not limited to, polyvinylidene fluoride (PVDF), carboxymethyl cellulose (CMC), styrene butadiene rubber (SBR), and combinations thereof. Suitable conductors and/or diluents include, but are not limited to, acetylene black, carbon black, conductive ceramics, and/or graphite or metallic powders such as powdered nickel, aluminum, titanium, stainless steel.

When the active particles are included in a negative electrode, the active particles can be more than 50 wt %, more than 80 wt %, or more than 90 wt %, and/or less than 99.9 wt %, less than 99 wt %, or less than 95 wt % of the total weight of the active layer. When a conductor is included in the active layer of a negative electrode in addition to the active particles, the conductor can be more than 0.01 wt %, more than 0.1 wt %, or more than 0.2 wt %, and/or less than 5 wt %, less than 3 wt %, or less than 1 wt % of the total weight of the active layer. When a binder is included in the active layer of a negative electrode in addition to the active particles, the binder can be more than 1 wt %, more than 5 wt %, or more than 10 wt %, and/or less than 40 wt %, less than 30 wt %, or less than 20 wt % of the total weight of the active layer.

When the electrode is a negative electrode, the active layer can be formed on the current collector by forming a negative slurry that includes the components of the negative medium and one or more solvents. The components of the negative medium include the active particles and none or at least one other component selected from the group consisting of binders, conductors, and diluents. Suitable solvents include, but are not limited to, 1-methyl-2-pyrrolidinone, N,N-dimethyl formamide, N,N-dimethyl acetoamide and combinations thereof. The negative slurry is coated on one side of the current collector or on both sides of the current collector. The one or more solvents can then be evaporated from the negative slurry so as to leave the negative layer on the current collector. In some instances, the thickness of the active layer can be adjusted to the desired thickness by pressing or other methods.

When the active particles are included in a positive electrode, suitable active materials for inclusion in the active medium include, but are not limited to, lithium iron phosphate, lithium nickel phosphate, lithium cobalt oxide, lithium manganese oxide, lithium vanadate, lithium nickel cobalt aluminum oxide and lithium nickel cobalt manganese oxide. Additionally, when the active particles are included in a positive electrode, suitable current collectors include, but are not limited to, aluminum, stainless steel, titanium, or nickel substrates. The positive current collector can be a foil, mesh, net, or plate.

When the active particles are included in a positive electrode, the active layer can consist of the active particles; however, in some instances, the active layer can include materials in addition to the active particles. For instance, in addition to the active particles, the active layer can include one or more components selected from a group consisting of binders, conductors and/or diluents. Suitable binders include, but are not limited to, polyvinylidene fluoride (PVDF), powdered fluoropolymer, powdered polytetrafluoroethylene, or powdered PVDF. Suitable conductors and/or diluents include, but are not limited to, acetylene black, carbon black and/or graphite or metallic powders such as powdered nickel, aluminum, titanium, stainless steel.

When the active particles are included in a positive electrode, the active particles can be more than 50 wt %, more than 80 wt %, or more than 90 wt %, and/or less than 99.9 wt %, less than 99 wt %, or less than 95 wt % of the total weight of the active layer. When a conductor is included in the active layer of a positive electrode in addition to the active particles, the conductor can be more than 0.01 wt %, more than 0.1 wt %, or more than 0.2 wt %, and/or less than 5 wt %, less than 3 wt %, or less than 1 wt % of the total weight of the active layer. When a binder is included in the active layer of a positive electrode in addition to the active particles, the binder can be more than 1 wt %, more than 5 wt %, or more than 10 wt %, and/or less than 40 wt %, less than 30 wt %, or less than 20 wt % of the total weight of the active layer.

When the electrode is a positive electrode, the active layer can be formed on the current collector by forming a positive slurry that includes the components of the positive medium and one or more solvents. The components of the positive medium include the active particles and none or at least one other component selected from the group consisting of binders, conductors, and diluents. Suitable solvents include, but are not limited to, 1-methyl-2-pyrrolidinone, N,N-dimethyl formamide, N,N-dimethyl acetoamide and combinations thereof The negative slurry is coated on one side of the current collector or on both sides of the current collector. The one or more solvents can then be evaporated from the negative slurry so as to leave the negative layer on the current collector. In some instances, the thickness of the active layer can be adjusted to the desired thickness by pressing or other methods.

When the active particles exclude a coating, the active medium can contact components of the active layer other than other active particles. For instance, if the active layer includes one or more components selected from binders, conductors and/or diluents, the active medium can contact these components. Additionally or alternately, the active medium can contact an electrolyte in the battery, and/or a separator in the battery. When the active particles include a coating, the coating can contact components of the active layer other than other active particles. For instance, if the active layer includes one or more components selected from binders, conductors and/or diluents, the coating can contact these components. Additionally or alternately, the coating can contact an electrolyte in the battery, and/or a separator in the battery.

The method of fabricating the active particles influences the structure that results. The method includes forming the elongated particles into bundles and then growing the active medium on the bundles. The bundles can be formed by applying a shear force to the elongated particles. The shear force can be applied by shaking, rubbing, or rolling the elongated particles. The shear force causes the aggregates (bundles) of the elongated particles to form as a result of entanglement of the elongated particles with one another. The entanglement of the elongated particles can allow different elongated particles to contact one another within the active medium. In some instances, the bundles are formed with a diameter greater than 0.1 μm, 1 μm, or 10 μm and/or less than 500 μm, 100 μm, or 50 μm. In one example, the elongated particles are carbon nanotubes or metal wires such as tin, silicon, or indium and have an average diameter of 1 nm to 1 μm and an average length of 10 nm to 100 μm. Shear force is applied to the elongated particles so as to form bundles having an average diameter of 1 to 500 μm.

To form mesophase carbon beads as the active medium, the bundles of elongated particles can be placed into amorphous coal tar pitch or amorphous petroleum pitch. Coal tar pitch is the by-products when coal is carbonized to make coke or gasified to make coal gas. Coal pitches are complex and variable mixtures of phenols, polycyclic aromatic hydrocarbons (PAHs), and heterocyclic compounds. Petroleum pitch is a mixture of organic liquids that are highly viscous, black, sticky, entirely soluble in carbon disulfide, and composed primarily of highly condensed polycyclic aromatic hydrocarbons. The result can be exposed to heat of about 400° C. to 450° C. in a nitrogen or argon atmosphere for a period of time in a range of 0.5 to 12 hours. This heat treatment causes mesophase carbon to form and grow in the interior of the bundles. At the end of the heat treatment, the active particles remain within the pitch. A solvent extraction can be employed to extract the active particles from the pitch. Suitable solvents include, but are not limited to, quinoline and/or toluene.

Following the extraction of the active particles from the pitch, the active particles can optionally be carbonized. For instance, the active particles can be exposed to a Nitrogen atmosphere at a temperature of about 600° C. to 1000° C. for a period of time in a range of 1 to 5 hours. The carbonization of the active particles causes remaining amorphous carbon to decompose and to be removed. At the same time, the carbonization of the active particles causes the mesophase to pack more densely. Additionally or alternately, the active particles can be graphitized. For instance, the active particles can be exposed to an Argon atmosphere at a temperature of about 2500° C. to 3000° C. for a period of time in a range of 1 to 12 hours. The graphitization of the active particles causes close packing of mesophase and formation of graphite. The carbonization and/or graphitization of the active particles is optional. In particular, the graphitization of the active particles is optional.

The porosity of the active particles can be controlled by adjusting the duration of the heat treatment during the formation of the mesocarbon in the pitch. For instance, longer heat treatments will reduce the porosity of the active medium while reducing the duration of the heat treatments increases the porosity of the active medium.

The above method of forming the active particles can be adapted to forming the active particles into fibers. For instance, the active particles can be formed so as to have an average diameter of greater than 10 nm, 50 nm, or 100 and/or less than 10 μm, 50 μm, or 100 μm while also having an average length greater than 100 μm, 200 μm, or 500 μm and/or less than 10 mm, 50 mm, or 100 mm. The high aspect ratio active of these materials can further enhance the power capability of the battery.

To form fiber shaped active particles, the bundles of elongated particles can be placed in the pitch and the mesophase carbon formed within the bundles. The result can be spun with or without performing the solvent extraction. Spinning provides the active particles with the fiber shape. For instance, spinning can elongated the active particles into particles having an aspect ratio in a range of 10 to 100,000. Additionally or alternately, in some instances, the spinning can result in the active particles having a diameter in a range of 1 to 50 μm and a length in a range of 0.1 mm to 100 mm. An example of spinning includes melt spinning at temperature of 300° C. at 3000 rpm.

After spinning, the active particles can optionally be oxidized in air. For instance, the active particles can be exposed an air atmosphere at a temperature of about 200° C. to 600° C. for a period of time in a range of 1 to 5 hours. In the event that the solvent extraction is not performed, the oxidation of the active particles can remove the amorphous pitch from the amorphous phase and can accordingly isolate the active particles with high crystalline phase. Additionally, the oxidation can introduce cross-linking among the active materials and increases the mechanical strength. Following oxidation of the active particles, the active particles can optionally be carbonized. For instance, the active particles can be exposed to a Nitrogen atmosphere at a temperature of about 600° C. to 1000° C. for a period of time in a range of 1 to 5 hours. The carbonization of the active particles causes densification of crystalline phase and/or removes amorphous carbon. Additionally or alternately, the active particles can be graphitized. For instance, the active particles can be exposed to an Argon atmosphere at a temperature of about 2500° C. to 3000° C. for a period of time in a range of 1 to 12 hours. The graphitization of the active particles causes close packing of crystalline phase and induces formation of graphite layers. The carbonization and/or graphitization of the active particles is optional. In particular, the graphitization of the active particles is optional.

The porosity of the active particles fibers that result from the above method be controlled by adjusting the duration of the heat treatment during the formation of the mesocarbon in the pitch. For instance, longer heat treatments will reduce the porosity of the active medium while reducing the duration of the heat treatments increases the porosity of the active medium. As noted above, the active medium can also include or consist of other active materials such as lithium metal oxides, lithium titanate, and lithium iron phosphate. These active particles can be also be made by growing the active medium within previously formed bundles of the elongated particles. For instance, the bundles and a solution can be formed. The solution can include one or more solvents combined with active material precursors. The active material precursors can include a lithium source such as lithium hydroxide and/or lithium carbonate. The active material precursors can also include the source of the metal in the active material. For instance, the active material precursor can include the source of the metal for a lithium metal oxides, the titanium for a lithium titanate, and iron for a lithium iron phosphate. As an example, the precursors can include a metal alkoxide, a metal nitride, and/or a metal sulfide. In particular, suitable precursors for lithium titanate include titanium isopropoxide and lithium acetate. suitable precursors for lithium iron phosphate include ammonium iron citrate (NH₄)ₓFe_{y}[C₃H_{S}O(COO)₃], triethyl phosphate PO(OC₂H₅), 99.8^{k} %), and lithium hydroxide monohydrate (LiOH.H₂O, 98⁺%). Examples of solvents for the solution include, but are not limited to, water, alcohol such as ethanol and/or other organic solvents such as 1-methyl-2-pyrrolidinone.

A precursor for the active medium can be grown in the interior of the bundles by employing a technique that removes the one or more solvents from the solution and deposits the resulting material on the interior of the bindles. Examples of these techniques include, but are not limited to, co-precipitation, spray drying, and colloidal deposition. These methods can provide hydrolysis of the precursors that promotes bonding between the lithium, metal, and oxygen and removal of solvent at the same time. The result can then be sintered to further crystallize the active medium. For instance, the result can be sintered in the presence of an inert gas. Examples of inert gasses include, but are not limited to nitrogen, and argon. As an example, the result can be exposed to an argon atmosphere at a temperature of about 600° C. to 1200° C. for a period of time in a range of 1 to 24 hours.

The resulting active particles can optionally be crushed to reduce the size of the active particles. For instance, crushing can reduce the size of the active particles to diameters ranging from 1 μm to 50 μm in diameter. The crushing can be by mechanical items such as a mill such as an air mill crusher. The active particles can optionally be sorted by size. For instance sieves can be employed to select active particles of particles have dimensions within a desired range.

When the active particles are to include one or more coatings, the one or more coatings can be formed after formation of the active medium within the elongated particles. For instance, traditional coating methods can be employed to form the coating on the active medium and elongated particles. Examples of suitable coating methods include, but are not limited to, solvent assisted blending, dry blending, and spray drying.

In one example of a suitable coating process, a coating slurry can be prepared that includes the materials for the coating in a solvent. The active particles can be placed in the coating slurry and the solvent dried so as to form the coating on the active particles. Examples of suitable solvents include chloroform, tetrahydrofurane, N,N-dimethylformamide, and ethanol. The coating slurry can include the coating materials at concentration in a range of about 1 to 10 wt %. The active particles can be collected by filtration and dried. The result can optionally be further carbonized. Carbonization can convert polymeric coating materials to a carbon or carbon rich coating. For instance, the active particles can be exposed to a Nitrogen atmosphere at a temperature of about 500° C. to 800° C.

In another method of forming the coating includes placing precursors for the coating material in the coating slurry and then reacting the precursors while the active particles are exposed to the precursors. For instance, when the coating will include lithium titanate, the precursors can include titanium isopropoxide and lithium acetate and the solvent can include ethanol. The precursors can be present in the ethanol at a concentration in a range of about 1 to 5 wt %. The coating slurry can be exposed to heat to react the precursors. For instance, the coating solution can be exposed to a temperature of about 80° C. for a period of time in a range of about 10 minutes to 1 hour. The active particles can be collected by filtration and dried. The result can optionally be sintered in order to promote crystallization of the coating material. For instance, the active particles can be exposed to an inert atmosphere at a temperature of about 800° C. for a period of time of about 1 hour. Examples of inert gasses include, but are not limited to nitrogen, and argon.

The above descriptions disclose performing various operations in a variety of different atmospheres. A particular atmosphere that does not specifically mention oxygen or air, preferably includes less than 10 molar % oxygen, or less than 1 molar % oxygen. In some instances, these atmospheres have less than 100 ppm oxygen.

The electrode can be included in a battery. The battery can be a primary battery or a secondary battery. As a result, the battery can include one or more positive electrodes and one or more negative electrode. In such a battery, one or more electrodes that include the active particles can serve as one or more of the positive electrodes and/or one or more of the negative electrodes. Alternately, the battery can include one or more anodes and one or more cathodes. In such a battery, one or more electrodes that include the active particles can serve as one or more of the cathodes and/or one or more of the anodes. Suitable battery structures include, but are not limited to, batteries having stacked electrode and batteries having wound electrodes.

Electrodes in the battery that exclude the active particles can have traditional structures and use traditional chemistries. For instance, when an electrode that excludes the active particles is a positive electrode or a cathode, the electrode can have a positive active medium on one or both sides of a positive current collector. Suitable positive current collectors include, but are not limited to, aluminum, stainless steel, titanium, or nickel substrates. The positive current collector can be a foil.

The positive active medium can includes or consists of one or more positive active materials. Suitable positive active materials include, but are not limited to, lithium transition metal oxides that also include one or more halogens (halo-lithium transition metal oxide). Suitable halo-lithium transition metal oxides include one or more transition metals included in a group consisting of Mn, Ni, Co, Fe, Cr, Cu. In one example, the halo-lithium transition metal oxides include Mn, Ni, Co and excludes other transition metals. The halogen in the halo-lithium transition metal oxides can include or consist of fluorine. For instance, a suitable halo-lithium transition metal can include fluorine can exclude other halogens or can include one or more other halogens. An example of the halo-lithium transition metal oxide is Li_{1.2}Ni_{0.2}Co_{0.1}Mn_{0.5}O₂F_{0.1} or Li_{1.2}Ni_{0.175}Co_{0.1}Mn_{0.53}O_{1.95}F_{0.05}.

The positive medium can optionally include binders, conductors and/or diluents such as PVDF, graphite and acetylene black in addition to the one or more positive active materials. Suitable binders include, but are not limited to, PVDF, powdered fluoropolymer, powdered polytetrafluoroethylene or powdered PVDF. Suitable conductors and/or diluents include, but are not limited to, acetylene black, carbon black and/or graphite or metallic powders such as powdered nickel, aluminum, titanium and stainless steel.

The positive electrode or cathode can be generated by forming a slurry that includes the components of the positive medium and a solvent. The slurry is coated on one side the positive current collector or on both sides of the positive current collector. The solvent can then be evaporated from the slurry so as to leave the positive medium on the current collector. The positive electrode can be cut out of the result. In other cases, the positive metal collector is deposited by vapor deposition technologies on the positive electrode.

When an electrode that excludes the active particles is a negative electrode or an anode, the electrode can have a negative active medium on one or both sides of a negative current collector. Suitable negative current collectors include, but are not limited to, lithium metal, titanium, a titanium alloy, stainless steel, nickel, copper, tungsten, tantalum, and alloys thereof. The negative current collector can be a foil, net, mesh, or plate. In some instances, the negative current collector also serves as the negative active medium such as when lithium metal serves as the negative current collector. Accordingly, the negative active medium can be optional.

Suitable negative active materials include, but are not limited to, a metal selected from Groups IA, IIA and IIIB of the Periodic Table of the Elements. Examples of these negative active materials include lithium, sodium, potassium, etc., and their alloys and intermetallic compounds including, for example, Li—Si, Li—Al, Li—B and Li—Si—B alloys and intermetallic compounds. Alternative suitable negative active materials include lithium alloys such as a lithium-aluminum alloy. Other suitable negative active materials include graphite or other carbon, silicon, silicon oxide, silicon carbide, germanium, tin, tin oxide, Cu₆Sn₅, Cu₂Sb, MnSb, other metal alloys, Li₄Ti₅O₁₂, silica alloys, or mixtures of suitable negative active materials.

The negative active medium can be formed on the current collector by forming a negative slurry that includes the components of the negative medium and a solvent. The negative slurry is coated on one side of the negative current collector or on both sides of the negative current collector. The solvent can then be evaporated from the negative slurry so as to leave the negative medium on the negative current collector.

Suitable separators for use between the electrodes of the battery include, but are not limited to, traditional separators such as polyolefins like polyethylene. Suitable electrolytes include one or more salts dissolved in a solvent. Suitable solvents include, but are not limited to, organic solvents and combinations of organic solvents.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A battery, comprising:
one or more electrodes that each has an active layer on a current collector,
the active layer including active particles,
the active particles including elongated particles embedded in an active medium such that at least a portion of the elongated particles each extends from within the active medium past a surface of the active medium.

2. The battery of claim 1, wherein the elongated particles are electrically conducting.

3. The battery of claim 1, wherein the elongated particles include one or more components selected from a group consisting of carbon fibers, carbon nanofibers, carbon nanotubes, metal wires, and metal nanowires.

4. The battery of claim 1, wherein at least a portion of the elongated particles have a lithium ion capacity greater than 500 mAh/g.

5. The battery of claim 1, wherein the elongated particles include one or more components selected from a group consisting of silicon wire, lithium wire, tin wire, and indium wire.

6. The battery of claim 1, wherein the active medium include mesophase carbon.

7. The battery of claim 1, wherein the active medium includes a lithium metal oxide.

8. The battery of claim 1, wherein at least a portion of the elongated particles extend more than 1 nm beyond the surface of the active medium.

9. The battery of claim 1, wherein the elongated particles have an aspect ratio greater than 10.

10. The battery of claim 1, wherein the active particles have the shape of a fiber in that the active particles have an average aspect ratio greater than 10.

11. The battery of claim 1, wherein the active particles include a coating contacting the active medium.

12. The battery of claim 11, wherein the coating has an average thickness less than 10 μm.

13. The battery of claim 11, wherein components of the active layer other than the active particles contact the coating.

14. The battery of claim 11, wherein an electrolyte in the battery contacts the coating.

15.-23. (canceled)
